(19) United States
(12) Patent Application Publication
(10) Pub. No.: US 2019/0052105 A1
(43) Pub. Date: Feb. 14, 2019

(54) METHOD FOR AUTOMATICALLY IDENTIFYING APPLE AND ANDROID DEVICES

(71) Applicant: Norel Systems Limited, Tianjin (CN)

(72) Inventors: Hui WANG, TIANJIN (CN); Ting Wu, Tianjin (CN); Wei Zhao, Tianjin (CN); Yuanlong Wang, Tianjin (CN)

(21) Appl. No.: 16/053,069

(22) Filed: Aug. 2, 2018

(30) Foreign Application Priority Data
Aug. 8, 2017 (CN) 201710670243.X

(51) Int. Cl. H02J 7/00; G06F 13/42

(52) U.S. Cl. CPC H02J 7/0052; G06F 13/4282; G06F 2213/0042; H02J 2007/0001; H02J 2007/0096; H02J 2007/0062

(57) ABSTRACT

A method for automatically identifying Apple and Android devices is provided, allowing a mobile charging apparatus to charge a charged device and perform USB data communication. The mobile charging apparatus enumerates the charged device in a USB Host mode to obtain VID information. If the VID information indicates that the charged device is an Apple device, the mobile charging apparatus switches to a USB Device mode, the charged device switches to the USB Host mode, and the charged device performs subsequent USB data communication with the mobile charging apparatus. If the VID information indicates that the charged device is an Android device, the mobile charging apparatus maintains the USB Host mode, the charged device maintains the USB Device mode, and the mobile charging apparatus performs subsequent USB data communication with the charged device. While performing USB data communication, the mobile charging apparatus can also charge the charged device.

### CROSS-REFERENCE TO RELATED PATENT APPLICATION

This application claims priority to and the benefit of, pursuant to 35 U.S.C. § 119(a), patent application Serial No. CN201710670243.X filed in China on Aug. 8, 2017. The disclosure of the above application is incorporated herein in its entirety by reference.

Some references, which may include patents, patent applications and various publications, are cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference were individually incorporated by reference.

### FIELD

The invention relates to the technical field of electronic accessories and mobile power supplies, in particular to a method for automatically identifying Apple and Android devices.

### BACKGROUND

At present, most mobile devices such as smart phones and tablets use Google's Android system and Apple's IOS system (Apple system for short). Mobile devices using Android system (Android devices for short) and mobile devices using Apple system (Apple devices for short) account for most of the market share. As the function of mobile devices becomes more and more powerful, users' demand for the built-in storage capacity of mobile devices is also continuously increasing. With the increase of the built-in storage capacity of the mobile devices, the price is also greatly increased. Mobile devices with large storage capacity often have lower price/performance ratio. Therefore, a growing number of mobile storage devices for mobile devices appear in the market to expand the storage capacity of mobile devices, which typically use a USB Micro B interface (connected to Android devices), a USB Micro AB interface (connected to Android devices), a USB type C interface (connected to Android devices) or a Lightning interface (connected to Apple devices) as the interface for connecting with the mobile devices. These mobile storage devices are usually not compatible with Android devices and Apple devices unless they use a dedicated OTG connecting line.

On the other hand, with the increase in the daily use time of mobile devices and the increase in the proportion of mobile device usage time occupied by applications with large power consumption such as mobile games, mobile phone videos, the increase in the battery capacity of the mobile devices is far from keeping up with the needs of the users. Therefore, the mobile power supply for charging the mobile devices is becoming more and more popular. Lithium batteries are commonly used as storage medium in mobile power supplies. Due to the advantages of small size, large capacity and moderate price, lithium batteries have been widely used. The housing of mobile power supplies usually includes a charging interface and a discharging interface. The most common type of interface is a USB interface. The USB interface was originally used to regulate the connection and communication between computers and external devices, and then has been widely used in various mobile portable devices.

The mobile power supply and the mobile storage device in the prior art have a single function, and the mobile power supply can only supply power to the mobile device, while the mobile storage device can only expand the storage capacity of the mobile device. If the Android device and the Apple device are used at the same time, a mobile storage device for each of the two mobile devices needs to be carried, thus causing inconvenience in use.

Therefore, how to automatically identify the Apple device and the Android device without changing the user's using habits, so that both the mobile devices can access the same extended storage medium and can also be charged at the same time, has become a technical problem to be solved at present.

### SUMMARY

The technical problem to be solved by the invention is how to automatically identify Apple and Android devices without changing the user's using habits, so that the two mobile devices can access the same extended storage medium, and a mobile charging apparatus can also charge the mobile devices at the same time.

In order to solve the above technical problem, the technical scheme adopted by the invention is as follows:

The invention provides a method for automatically identifying Apple and Android devices, by which a mobile charging apparatus is allowed to charge a charged device and perform USB data communication, the mobile charging apparatus comprising a first USB interface which is connected with the charged device through a first USB cable,

the mobile charging apparatus configures the first USB interface into a charging and communication mode, in which the charged device receives discharge of the mobile charging apparatus through the first USB interface and may perform USB data communication with the mobile charging apparatus simultaneously,

the charged device performs USB connection with the mobile charging apparatus in a USB Device mode,

the mobile charging apparatus enumerates the charged devices in a USB Host mode, and in the enumeration process, the mobile charging apparatus obtains a USB device descriptor from the charged device and reads VID information in the USB device descriptor,

if the VID information shows that the charged device is an Apple device, after the enumeration process is completed, Role Switch is performed, the mobile charging apparatus is switched to the USB Device mode, the charged device is switched to the USB Host mode, and the charged device and the mobile charging apparatus perform subsequent USB data communication, and

if the VID information indicates that the charged device is an Android device, after the enumeration process is completed, the mobile charging apparatus maintains the USB Host mode, the charged device maintains the USB Device mode, and the mobile charging apparatus performs subsequent USB data communication with the charged device.

Preferably, the process of performing Role Switch, switching the mobile charging apparatus to the USB Device mode and switching the charged device to the USB Host mode is that the mobile charging apparatus sends a Role Switch request to the charged device which disconnects the USB data connection after receiving the Role Switch request, the mobile charging apparatus switches from the USB Host mode to the USB Device mode after recognizing that the charged device has disconnected the USB data connection, the charged device switches from the USB Device mode to the USB Host mode, and the charged device reestablishes the USB data connection with the mobile charging apparatus.

Preferably, the mobile charging apparatus further comprises a storage device, wherein the charged device performs USB data communication with the mobile charging apparatus and performs read and write operations on the storage device. Further preferably, the storage device is a flash memory card, a flash memory chip, or a hard disk.

Preferably, the mobile charging apparatus further comprises a wireless transmitting and receiving apparatus, wherein the charged device performs USB data communication with the mobile charging apparatus and transmits and receives data through the wireless transmitting and receiving apparatus.

Preferably, the mobile charging apparatus can transmit battery power and state information to the charged device through USB data communication.

Preferably, the first USB interface is a USB type A receptacle, and two ends of the first USB cable are provided with a USB type A plug and a Lightning plug, respectively, wherein the USB type A plug is connected with the mobile charging apparatus, and the Lightning plug is connected with the charged device.

Preferably, the first USB interface is a USB type A receptacle, and the two ends of the first USB cable are provided with a USB type A plug and a USB Micro B plug, respectively, wherein the USB type A plug is connected with the mobile charging apparatus, and the USB Micro B plug is connected with the charged device.

Preferably, the first USB interface is a USB type A receptacle, and the two ends of the first USB cable are provided with a USB type A plug and a USB type C plug, respectively, wherein the USB type A plug is connected with the mobile charging apparatus, and the USB type C plug is connected with the charged device.

Preferably, the first USB interface is a USB type C receptacle, and the two ends of the first USB cable are provided with a USB type C plug and a Lightning plug, respectively, wherein the USB type C plug is connected with the mobile charging apparatus, and the Lightning plug is connected with the charged device.

Preferably, the first USB interface is a USB type C receptacle, and the two ends of the first USB cable are provided with a USB type C plug and a USB Micro B plug, respectively, wherein the USB type C plug is connected with the mobile charging apparatus, and the USB Micro B plug is connected with the charged device.

Preferably, the first USB interface is a USB type C receptacle, and the two ends of the first USB cable are provided with a USB type C plug and a USB type C plug, respectively, wherein the USB type C plug is connected with the mobile charging apparatus, and the USB type C plug is connected with the charged device.

Preferably, the mobile charging apparatus further comprises a second USB interface. When the second USB interface of the mobile charging apparatus is connected with a PC host via a second USB cable, the mobile charging apparatus selectively performs USB data communication with the PC host via the second USB cable or performs USB data communication with the charged device via the first USB cable.

Preferably, the charged device is a mobile device running an Apple system with a Lightning receptacle.

Preferably, the charged device is a mobile device running an Android system with a USB Micro B receptacle or a USB Micro AB receptacle or a USB type C receptacle.

The invention has the following beneficial effects that:

The method for automatically identifying Apple and Android devices of the present invention involves the mobile charging apparatus which identifies whether the charged device is an Apple device or an Android device by judging the VID information, and thus makes the charged device and the mobile charging apparatus to work in the USB Device mode or the USB Host mode, respectively, such that the charged device, whether the Apple device or the Android device, can perform USB data communication with the mobile charging apparatus, access the same extended storage medium in the mobile charging apparatus, and can also be charged by the mobile charging apparatus at the same time.

### BRIEF DESCRIPTION OF THE DRAWINGS

The present invention will be further explained below with reference to the accompanying drawings and examples:

FIG. 1 is an internal functional module diagram of a mobile charging apparatus involved in a method for automatically identifying Apple and Android devices of the present invention and an external signal connection diagram when the mobile charging apparatus is connected with the Apple device.

FIG. 2 is an internal functional module diagram of the mobile charging apparatus involved in the method for automatically identifying the Apple device and the Android device of the present invention and an external signal connection diagram when the mobile charging apparatus is connected with the Android device.

In which:

| | | | |
|---|---|---|---|
| 1 | mobile charging apparatus | 2 | charged device |
| 3 | power adapter or PC host | 11 | battery |
| 12 | discharging control module | 13 | charging control module |
| 14 | first USB interface | 15 | second USB interface |
| 16 | micro-control unit | 17 | storage device |
| 18 | wireless transmitting and | 21 | first USB cable |
| | receiving apparatus | | |
| 31 | second USB cable | | |

### DETAILED DESCRIPTION

A method for automatically identifying Apple and Android devices according to the present invention will be further explained with reference to the embodiments shown in the accompanying drawings.

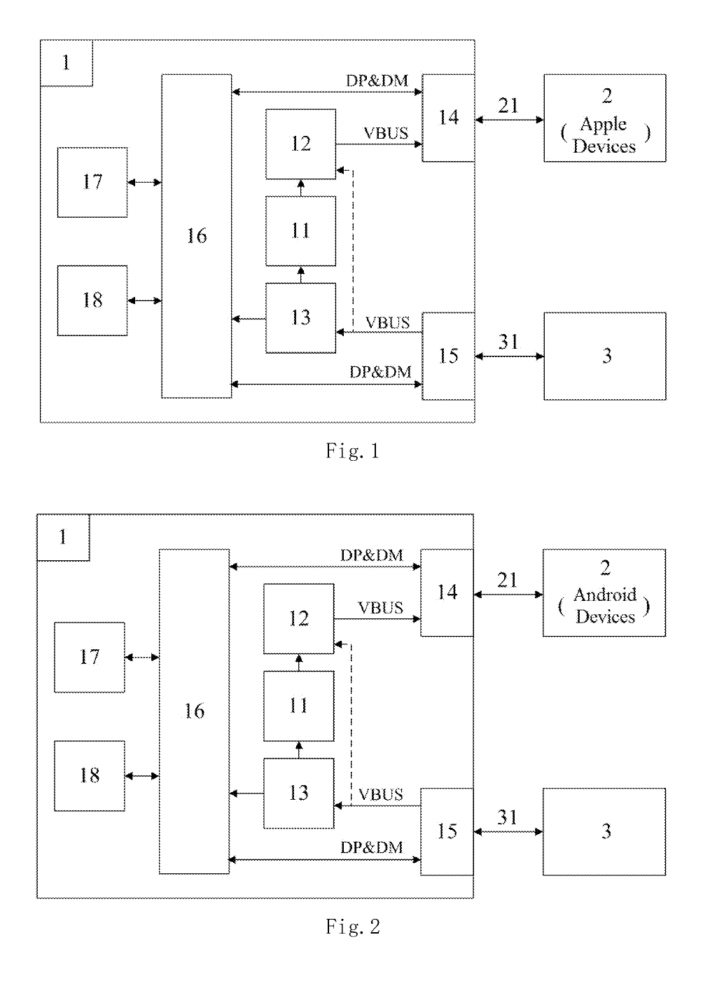

As shown in FIG. 1, in an application embodiment of the present invention, a method for automatically identifying Apple and Android devices is provided, by which a mobile charging apparatus 1 is allowed to charge and perform USB data communication with a charged device 2. The charged device 2 is an Apple device. The mobile charging apparatus 1 includes a battery 11, a discharging control module 12, a charging control module 13, a first USB interface 14, a second USB interface 15, and a micro-control unit 16. The first USB interface 14 is connected to a USB interface of the charged device 2 through a first USB cable 21. VBUS, DP, DM and ground signals of the first USB cable 21 are connected to VBUS, DP, DM and ground signals of the first USB interface 14. The VBUS of the first USB interface 14 is connected to the discharging control module 12, and the DP and DM signals of the first USB interface 14 are connected to the micro-control unit 16.

The micro-control unit 16 of the mobile charging apparatus 1 configures the first USB interface 14 into a charging and communication mode according to a fast charging protocol. In the charging and communication mode, the mobile charging apparatus 1 is powered by the VBUS, and the charged device 2 receives discharge of the mobile charging apparatus 1 through the VBUS, and can perform USB data communication with the mobile charging apparatus 1 through the DP and DM simultaneously.

After the charged device 2 detects that the first USB interface 14 is in the charging and communication mode, the charged device 2 is connected with the micro-control unit 16 in a USB Device mode. The micro-control unit 16 enumerates the charged device 2 in a USB Host mode. During enumeration, the micro-control unit 16 sends a Get Descriptor command to the charged device 2 through the DP and DM of the first USB interface 14. After receiving the USB device descriptor returned by the charged device 2, the micro-control unit 16 reads VID (vendor ID) information in the USB device descriptor. If the VID is a value assigned to Apple by USB-IF, then the charged device 2 is an Apple device. After the enumeration process is completed, the micro-control unit 16 sends a Role Switch request to the charged device 2 according to Apple′ Accessory Interface Specification. The charged device 2 disconnects the USB data connection after receiving the Role Switch request. After the micro-control unit 16 detects that the charged device 2 has disconnected the USB data connection, it switches from the USB Host mode to the USB Device mode, and the charged device 2 switches from the USB Device mode to the USB Host mode and reestablishes USB data connection with the micro-control unit 16. The charged device 2 performs USB data communication with the micro-control unit 16 through the DP and DM of the first USB interface 14, and at the same time, the battery 11 may charge the charged device 2 through the discharge control module 12 and the VBUS of the first USB interface 14.

The second USB interface 15 is connected to the charging control module 13 which is connected to the battery 11. The second USB interface 15 may be connected to a power adapter or a PC host 3 through a second USB cable 31 to charge the battery 11.

The charging control module 13 is also connected to the micro-control unit 16 which obtains battery power and state information through the charging control module 13. DP and DM signals of the second USB interface 15 are connected to the micro-control unit 16. When the second USB interface 15 is connected to the PC host via the second USB cable 31, the micro-control unit 16 selectively performs USB data communication with the PC host via the second USB interface 15 or performs USB data communication with the charged device 2 via the first USB interface 14.

The second USB interface 15 in this embodiment can be replaced by a common power socket. At this time, the power adapter or PC host 3 charges the battery 11 through the ordinary power socket, but without DP and DM signals, it cannot perform USB data communication with the mobile charging apparatus 1.

In this embodiment, the battery 11 and the charging control module 13 may not be included. At this time, the power adapter or PC host 3 is directly connected to the discharging control module 12 through the second USB interface 15 or the common power socket.

In this embodiment, the mobile charging apparatus 1 may optionally include a storage device 17 or a wireless transmitting and receiving apparatus 18.

When the mobile charging apparatus 1 includes the storage device 17, the micro-control unit 16 is connected to the storage device 17. In the charging and communication mode, the charged device 2 performs USB data communication with the micro-control unit 16 through the DP and DM of the first USB interface 14, and performs read and write operations on the storage device 17. The storage device 17 is a flash memory card, a flash memory chip, or a hard disk.

When the mobile charging apparatus 1 includes the wireless transmitting and receiving apparatus 18, the micro-control unit 16 is connected to the wireless transmitting and receiving apparatus 18. In the charging and communication mode, the charged device 2 performs USB data communication with the micro-control unit 16 through the DP and DM of the first USB interface 14, and transmits and receives data through the wireless transmitting and receiving apparatus 18.

In this embodiment, in order to be consistent with common mobile power supplies, the first USB interface 14 is a USB type A receptacle, the charged device 2 is a mobile device running the Apple system and having a Lightning receptacle, and two ends of the first USB cable 21 are provided with a USB type A plug and a Lightning plug, respectively. The first USB interface 14 may also be a USB type C receptacle, the charged device 2 is a mobile device running the Apple system and having a Lightning receptacle, and the two ends of the first USB cable 21 are provided with a USB type C plug and a Lightning plug, respectively.

As shown in FIG. 2, in another application embodiment of the present invention, a method for automatically identifying Apple and Android devices is provided, by which a mobile charging apparatus 1 is allowed to charge and perform USB data communication with a charged device 2. The charged device 2 is an Android device. The mobile charging apparatus 1 includes a battery 11, a discharging control module 12, a charging control module 13, a first USB interface 14, a second USB interface 15, and a micro-control unit 16. The first USB interface 14 is connected to a USB interface of the charged device 2 through a first USB cable 21. VBUS, DP, DM and ground signals of the first USB cable 21 are connected to VBUS, DP, DM and ground signals of the first USB interface 14. The VBUS of the first USB interface 14 is connected to the discharging control module 12, and the DP and DM signals of the first USB interface 14 are connected to the micro-control unit 16.

The micro-control unit 16 of the mobile charging apparatus 1 configures the first USB interface 14 into a charging and communication mode according to a fast charging protocol. In the charging and communication mode, the mobile charging apparatus 1 is powered by the VBUS, and the charged device 2 receives discharge of the mobile charging apparatus 1 through the VBUS, and can perform USB data communication with the mobile charging apparatus 1 through the DP and DM simultaneously.

After the charged device 2 detects that the first USB interface 14 is in the charging and communication mode, the charged device 2 is connected with the micro-control unit 16 in a USB Device mode. The micro-control unit 16 enumerates the charged device 2 in a USB Host mode. During enumeration, the micro-control unit 16 sends a Get Descriptor command to the charged device 2 through the DP and DM of the first USB interface 14. After receiving the USB device descriptor returned by the charged device 2, the micro-control unit 16 reads VID (vendor ID) information in the USB device descriptor. If the VID is not a value assigned to Apple by USB-IF, then the charged device 2 is an Android device. After the enumeration process is completed, the micro-control unit 16 maintains the USB Host mode, and the charged device 2 maintains the USB Device mode. The micro control unit 16 performs USB data communication with the charged device 2 through the DP and DM of the first USB interface 14, and at the same time, the battery 11 charges the charged device 2 through the discharge control module 12 and the VBUS of the first USB interface 14.

The second USB interface 15 is connected to the charging control module 13 which is connected to the battery 11. The second USB interface 15 may be connected to a power adapter or a PC host 3 through a second USB cable 31 to charge the battery 11.

The charging control module 13 is also connected to the micro-control unit 16 which obtains battery power and state information through the charging control module 13.

DP and DM signals of the second USB interface 15 are connected to the micro-control unit 16. When the second USB interface 15 is connected to the PC host via the second USB cable 31, the micro-control unit 16 selectively performs USB data communication with the PC host via the second USB interface 15 or performs USB data communication with the charged device 2 via the first USB interface 14.

The second USB interface 15 in this embodiment can be replaced by a common power socket. At this time, the power adapter or PC host 3 charges the battery 11 through the ordinary power socket, but without DP and DM signals, it cannot perform USB data communication with the mobile charging apparatus 1.

In this embodiment, the battery 11 and the charging control module 13 may not be included. At this time, the power adapter or PC host 3 is directly connected to the discharging control module 12 through the second USB interface 15 or the common power socket.

In this embodiment, the mobile charging apparatus 1 may optionally include a storage device 17 or a wireless transmitting and receiving apparatus 18.

When the mobile charging apparatus 1 includes the storage device 17, the micro-control unit 16 is connected to the storage device 17. In the charging and communication mode, the charged device 2 performs USB data communication with the micro-control unit 16 through the DP and DM of the first USB interface 14, and performs read and write operations on the storage device 17. The storage device 17 is a flash memory card, a flash memory chip, or a hard disk.

When the mobile charging apparatus 1 includes the wireless transmitting and receiving apparatus 18, the micro-control unit 16 is connected to the wireless transmitting and receiving apparatus 18. In the charging and communication mode, the charged device 2 performs USB data communication with the micro-control unit 16 through the DP and DM of the first USB interface 14, and transmits and receives data through the wireless transmitting and receiving apparatus 18.

In this embodiment, in order to be consistent with common mobile power supplies, the first USB interface 14 is a USB type A receptacle, the charged device 2 is a mobile device running the Android system and having a USB Micro B or USB Micro AB receptacle, and two ends of the first USB cable 21 are provided with a USB type A plug and a USB Micro B plug, respectively. The first USB interface 14 may also be a USB type C receptacle, the charged device 2 is a mobile device running the Android system and having a USB Micro B or USB Micro AB receptacle, and the two ends of the first USB cable 21 are provided with a USB type C plug and a USB Micro B plug, respectively. The first USB interface 14 may also be a USB Type C receptacle, the charged device 2 is a mobile device running the Android system and having a USB Type C receptacle, and the two ends of the first USB cable 21 are provided with a USB Type C plug and a USB Type C plug, respectively.

In the two embodiments shown in FIGS. 1 and 2, the fast charging protocol may be USB Battery Charging Protocol, Qualcomm Quick Charge Protocol, Huawei Fast Charger Protocol, Samsung Adaptive Fast Charging Protocol, Mediatek Pump Express Charging Protocol, or Apple Fast Charging Protocol.

USB Battery Charging Protocol (hereinafter referred to as USB BC Protocol) specifies the criteria to be followed for charging the batteries of portable devices using the USB interface. In fact, the core of the USB BC Protocol is to introduce a charging port identification mechanism through which a portable USB device conforming to the USB BC Protocol can identify whether it is plugged into a standard USB Downstream Port (hereinafter referred to as SDP), a USB Dedicated Charger (hereinafter referred to as DCP), or a USB Downstream Port (hereinafter referred to as CDP) optimized for charging.

According to the USB BC Protocol, when the USB interface is configured as SDP, its DP and DM signals are respectively connected with a nominal 15K pull-down resistor to ground. When the USB interface is configured as DCP, its DP and DM signals have no pull-down resistor to ground, but there is a resistance less than 200 ohms between DP and DM. The charged device 2 identifies the SDP or DCP mode by detecting these two different states.

In the two embodiments shown in FIGS. 1 and 2, the micro-control unit 16 may use the SDP defined by the USB BC Protocol as the charging and communication mode. In case of the SDP mode, the micro-control unit 16 connects the DP and DM signals to a nominal 15K pull-down resistor to ground, respectively. The VBUS supply voltage of the first USB interface 14 is 5 V. After detecting the SDP mode, the charged device 2 takes power from the VBUS of the first USB interface 14 at a maximum of 500 mA. Meanwhile, the charged device 2 may also perform USB data communication with the micro-control unit 16 through the DP and DM signals. The micro-control unit 16 may also use the DCP defined by the USB BC Protocol as the charging and communication mode, in which the USB interface can perform USB data communication or can be used for fast charging at a power exceeding 5 V and 500 mA. However, the CDP mode is not widely supported in practical applications due to its poor compatibility.

When the charged device 2 is an Apple device, after the Role Switch process is completed, the micro-control unit 16 can communicate with the charged device 2 according to the Apple′ Accessory Interface Specification to change the maximum charging current.

The DCP mode defined by the USB BC Protocol only allows fast charging, and USB data communication cannot be performed while charging. The DCP mode and other modes defined by the above-mentioned fast charging Protocols will not be described one by one here.

As the functions of mobile devices become more and more powerful, the built-in storage capacity and battery capacity of the mobile devices cannot meet the users' demand. It is often necessary to provide mobile power for the mobile devices and expand the storage capacity. How to automatically identify Apple and Android devices without changing the users' using habits, so that both the two mobile devices can access the same extended storage medium and can also be charged at the same time has become a technical problem to be solved at present. The method for automatically identifying Apple and Android devices of the present invention involves the mobile charging apparatus which identifies whether the charged device is an Apple device or an Android device by judging the VID information, and thus makes the charged device and the mobile charging apparatus to work in the USB Device mode or the USB Host mode, respectively, such that the charged device, whether the Apple device or the Android device, can perform USB data communication with the mobile charging apparatus, access the same extended storage medium in the mobile charging apparatus, and can also be charged by the mobile charging apparatus at the same time.

The above is merely a description of preferred embodiments of the present invention and is not intended to limit the present invention in any way. The protection scope of the present invention should be based on what is stated in the claims. All simple changes, equivalent substitutions or decomposition and combination of the above specific embodiments according to the technical essence of the present invention fall within the protection scope of the technical scheme of the present invention.

What is claimed is:

1. A method for automatically identifying Apple and Android devices, by which a mobile charging apparatus is allowed to charge a charged device and perform USB data communication, wherein the mobile charging apparatus comprises a first USB interface, the first USB interface being connected with the charged device through a first USB cable, and is characterized in that:
the mobile charging apparatus configures the first USB interface into a charging and communication mode, in which the charged device receives discharge of the mobile charging apparatus through the first USB interface and can perform USB data communication with the mobile charging apparatus simultaneously,
the charged device performs USB connection with the mobile charging apparatus in a USB Device mode,
the mobile charging apparatus enumerates the charged devices in a USB Host mode, and in the enumeration process, the mobile charging apparatus obtains a USB device descriptor from the charged device and reads VID information in the USB device descriptor,
if the VID information indicates that the charged device is an Apple device, after the enumeration process is completed, Role Switch is performed, the mobile charging apparatus is switched to the USB Device mode, the charged device is switched to the USB Host mode, and the charged device and the mobile charging apparatus perform subsequent USB data communication, and
if the VID information indicates that the charged device is an Android device, after the enumeration process is completed, the mobile charging apparatus maintains the USB Host mode, the charged device maintains the USB Device mode, and the mobile charging apparatus performs subsequent USB data communication with the charged device.

2. The method for automatically identifying Apple and Android devices according to claim 1, characterized in that:
the process of performing Role Switch, switching the mobile charging apparatus to the USB Device mode and switching the charged device to the USB Host mode is that the mobile charging apparatus sends a Role Switch request to the charged device which disconnects the USB data connection after receiving the Role Switch request, the mobile charging apparatus switches from the USB Host mode to the USB Device mode after recognizing that the charged device has disconnected the USB data connection, the charged device switches from the USB Device mode to the USB Host mode, and the charged device reestablishes the USB data connection with the mobile charging apparatus.

3. The method for automatically identifying Apple and Android devices according to claim 1, characterized in that:
the mobile charging apparatus further comprises a storage device, wherein the charged device performs USB data communication with the mobile charging apparatus and performs read and write operations on the storage device.

4. The method for automatically identifying Apple and Android devices according to claim 3, characterized in that:
the storage device is a flash memory card, a flash memory chip or a hard disk.

5. The method for automatically identifying Apple and Android devices according to claim 1, characterized in that:
the mobile charging apparatus further comprises a wireless transmitting and receiving apparatus, wherein the charged device performs USB data communication with the mobile charging apparatus and transmits and receives data through the wireless transmitting and receiving apparatus.

6. The method for automatically identifying Apple and Android devices according to claim 1, characterized in that:
the mobile charging apparatus may transmit battery power and state information to the charged device through USB data communication.

7. The method for automatically identifying Apple and Android devices according to claim 1, characterized in that:
two ends of the first USB cable are provided with a USB type A plug and a Lightning plug, respectively, wherein the USB type A plug is connected with the mobile charging apparatus, and the Lightning plug is connected with the charged device.

8. The method for automatically identifying Apple and Android devices according to claim 1, characterized in that:
the two end of the first USB cable are provided with a USB type A plug and a USB Micro B plug, respectively, wherein the USB type A plug is connected with the mobile charging device, and the USB Micro B plug is connected with the charged device.

9. The method for automatically identifying Apple and Android devices according to claim 1, characterized in that:
the two ends of the first USB cable are provided with a USB type A plug and a USB type C plug, respectively, wherein the USB type A plug is connected with the mobile charging apparatus, and the USB type C plug is connected with the charged device.

10. The method for automatically identifying Apple and Android devices according to claim 1, characterized in that:
the two ends of the first USB cable are provided with a USB type C plug and a Lightning plug, respectively, wherein the USB type C plug is connected with the mobile charging apparatus, and the Lightning plug is connected with the charged device.

11. The method for automatically identifying Apple and Android devices according to claim 1, characterized in that:
the two ends of the first USB cable are provided with a USB type C plug and a USB Micro B plug, respectively, wherein the USB type C plug is connected with the mobile charging apparatus, and the USB Micro B plug is connected with the charged device.

12. The method for automatically identifying Apple and Android devices according to claim 1, characterized in that:
the two ends of the first USB cable are provided with a USB type C plug and a USB type C plug, respectively, which are respectively connected with the mobile charging apparatus and the charged device.

13. The method for automatically identifying Apple and Android devices according to claim 1, characterized in that:
the mobile charging apparatus further includes a second USB interface, when the second USB interface of the mobile charging apparatus is connected to a PC host via a second USB cable, and the mobile charging apparatus selectively performs USB data communication with the PC host via the second USB cable or performs USB data communication with the charged device via the first USB cable.

14. The method for automatically identifying Apple and Android devices according to claim 1, characterized in that:
the charged device is a mobile device running an Apple system and having a Lightning receptacle.

15. The method for automatically identifying Apple and Android devices according to claim 1, characterized in that:
the charged device is a mobile device running an Android system and having a USB Micro B receptacle or a USB Micro AB receptacle or a USB type C receptacle.
